(19) United States
(12) Patent Application Publication
(10) Pub. No.: US 2010/0064911 A1
(43) Pub. Date: Mar. 18, 2010

(54) EMBOSSING DEVICE AND METHODS FOR USING AND MANUFACTURING THE SAME

(75) Inventors: James T. Davis, II, Springville, UT (US); Matthew B. Strong, Pleasant Grove, UT (US); Jeffrey V. Gubler, Springville, UT (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Provo Craft and Novelty, Inc., Spanish Fork, UT (US)

(21) Appl. No.: 12/477,023

(22) Filed: Jun. 2, 2009

Related U.S. Application Data
(60) Provisional application No. 61/057,883, filed on Jun. 2, 2008.

(51) Int. Cl. B41F 19/02

(52) U.S. Cl. 101/26

(57) ABSTRACT

An assembly is disclosed. The assembly includes an embossing device including a blank portion workpiece including a plurality of layers, wherein the blank portion workpiece is separated to include a first blank portion and a second blank portion, wherein each of the first and second blank portions include portions of at least two layers of the plurality of layers; and a blank portion retainer including a first flap and a second flap, wherein the first flap and the second flap are connected by a member consisting of a hinge, wherein the hinge and the first flap and the second flap define a folder, wherein each of the first and second flaps define an inner surface and an outer surface, wherein the first blank portion is attached to the inner surface of the first flap, wherein the second blank portion is attached to the inner surface of the second flap

### RELATED APPLICATION

This application claims the benefit of U.S. Provisional Patent Application Ser. No. 61/057,883 filed on Jun. 2, 2008, the contents of which are fully incorporated herein by reference.

### FIELD OF THE INVENTION

The disclosure relates to an embossing device, a method for using an embossing device, and a method for manufacturing an embossing device.

### DESCRIPTION OF THE RELATED ART

“Scrap-booking” is a method of associating visual media with a collection of album pages (often referred to as a “scrap-book”). The visual media associated with the scrap-book typically includes one or more photographs, decorations and/or printed material (e.g., a poem, short-story, newspaper article, or the like). An exemplar scrap-book that may retain visual media is shown, for example, in U.S. Pat. No. 140,245 to Samuel L. Clemens (also known under the pen-name, “Mark Twain”).

Although conventional scrap-books like the one issued to “Mark Twain” on Jun. 24, 1873 are suitable for their intended purpose, with advances in modem technology, such scrapbooks are nevertheless susceptible to improvements that may enhance or improve their usage or method of manufacture. Therefore, a need exists in the art for the development of improved scrapbooks and scrapbook components that advance the art.

### BRIEF DESCRIPTION OF THE DRAWINGS

The disclosure will now be described, by way of example, with reference to the accompanying drawings, in which:

FIG. 1A is an exploded perspective view of an embossing device that includes a folder and a plurality of layers defining an embossing blank in accordance with an exemplary embodiment of the invention;

FIG. 1B is another exploded perspective view of an embossing device of FIG. 1A including the embossing blank that has been modified to define a first blank portion and a second blank portion in accordance with an exemplary embodiment of the invention;

FIG. 1C is an assembled perspective view of the embossing device of FIG. 1B in accordance with an exemplary embodiment of the invention;

FIG. 2 is a perspective view of a system for modifying the plurality of layers defining the embossing blank of FIG. 1A in accordance with an exemplary embodiment of the invention;

FIGS. 3A-3F illustrate a method for manufacturing the embossing device of FIG. 1C in accordance with an exemplary embodiment of the invention;

FIGS. 4A-4F illustrate a cross-sectional view of the method for manufacturing the embossing device according to lines 4A-4A through 4F-4F of FIGS. 3A through 3F in accordance with an exemplary embodiment of the invention;

FIG. 5A illustrates a perspective view of a workpiece being inserted into and interfaced with the embossing device of FIG. 1C in accordance with an exemplary embodiment of the invention;

FIG. 5B illustrates a perspective view of the workpiece of FIG. 5A removed from the embossing device such that the embossing device has modified the workpiece to include an embossed pattern in accordance with an exemplary embodiment of the invention; and

FIGS. 6A-6B illustrate perspective views of a pressing device that interfaces with the embossing device and a workpiece in accordance with an exemplary embodiment of the invention.

### DETAILED DESCRIPTION OF THE INVENTION

The Figures illustrate an exemplary embodiment of an embossing device and method for using and manufacturing the same in accordance with an embodiment of the invention. Based on the foregoing, it is to be generally understood that the nomenclature used herein is simply for convenience and the terms used to describe the invention should be given the broadest meaning by one of ordinary skill in the art. This application claims the benefit of U.S. Provisional Patent Application Ser. No. 61/057,883 filed on Jun. 2, 2008, the contents of which are fully incorporated herein by reference.

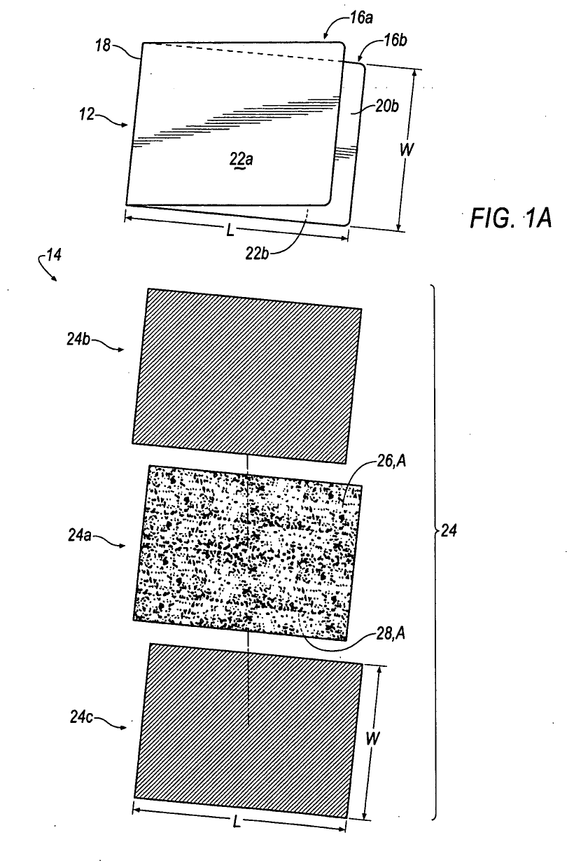

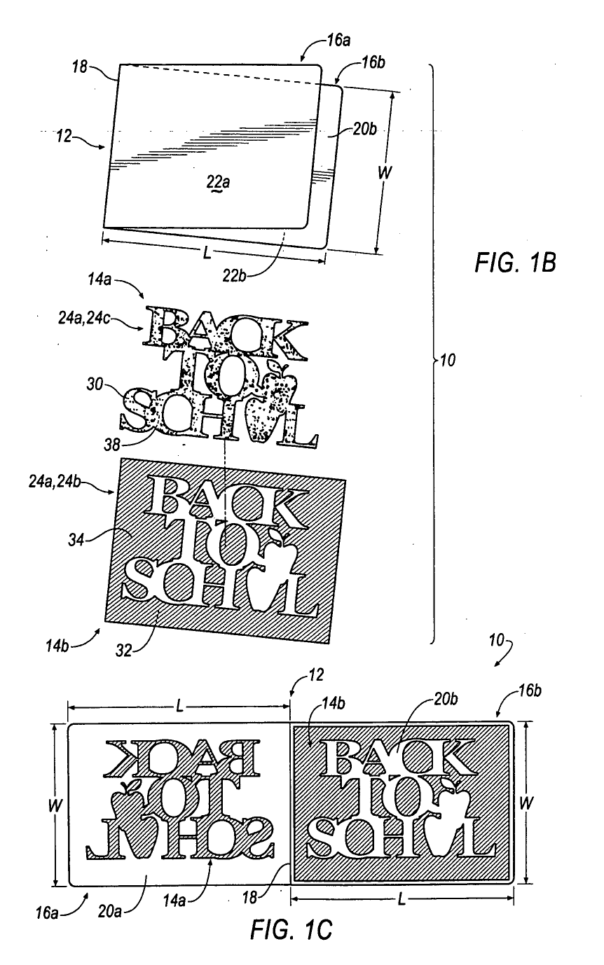

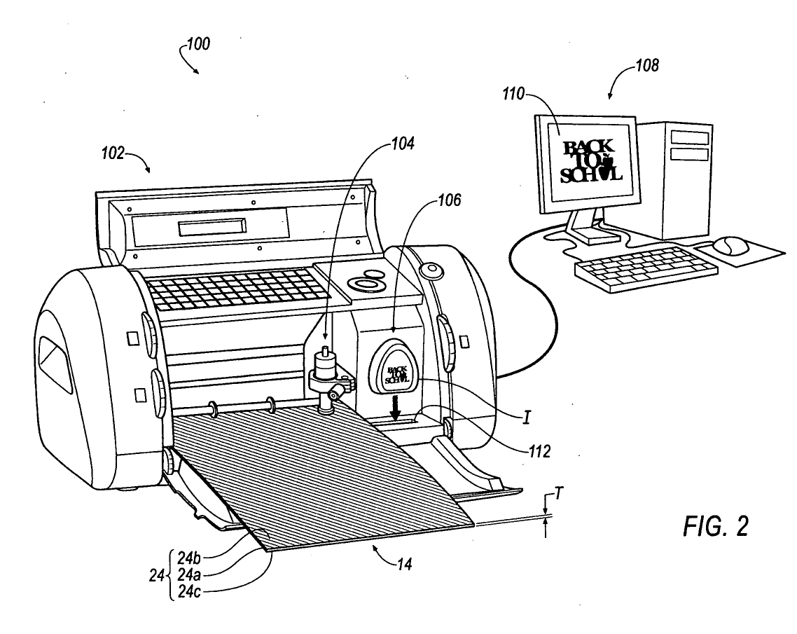

An embossing device is shown generally at 10 (see, e.g., FIGS. 1B-1C) in accordance with an embodiment of the invention. Referring to FIGS. 1A-1C, the embossing device 10 generally includes a folder portion 12 and first and second blank portions 14a, 14b (see, e.g., FIG. 1B) that are formed from a blank portion workpiece 14 (see, e.g., FIG. 1A). In an embodiment, the folder portion 12 and a blank portion workpiece 14 may be sold in a kit such that the blank portion workpiece 14 may be modified to include the first and second blank portions 14a, 14b that are later attached to the folder portion 12; accordingly, in an embodiment, the folder portion 12 and the blank portion workpiece 14 may be provided together (in an un-attached state) within one enclosure (not shown), or, alternatively in individual enclosures. In an embodiment, the enclosure may include, for example, a bag, box or the like). Further, when it is desired to assemble the embossing device 10, the folder portion 12 and blank portion workpiece 14 may be removed from the one or more enclosures.

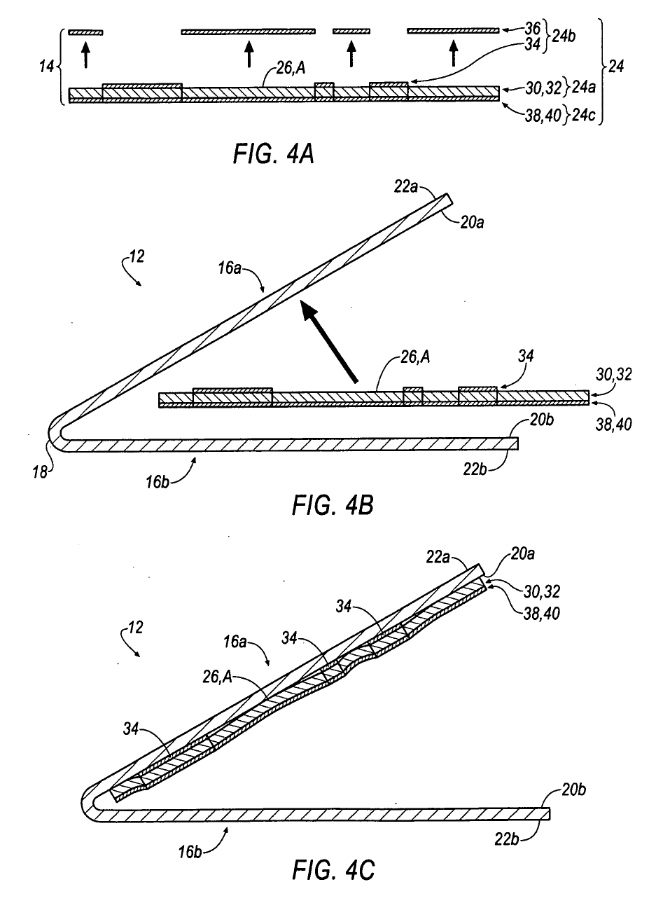

In an embodiment, the folder portion 12 is generally defined by a first flap 16a and a second flap 16b that are utilized for respectively retaining the first and second blank portions 14a, 14b thereto. The folder portion 12 is also defined by a hinge 18 that connects the first flap 16a to the second flap 16b while also ensuring that the first and second blank portions 14a, 14b are repeatably and consistently aligned with one another (see, e.g., FIG. 4E) when the first flap 16a and second flap 16b are moved toward one another during, e.g., an embossing procedure. Further, in an embodiment, each of the first and second flaps 16a, 16b may define a length, L, and a width, W; accordingly, the inclusion of the hinge 18 permits the folder portion 12 to act as a one-piece structure that may have a length approximately equal to L×2 and a width approximately equal to W×1. As such, it will be appreciated that the hinge 18 permits the folder portion 12 to provide an integral, simplified, compact structure that is free of/eliminates the need for separate connection structure (e.g., pins, holes, notches, flanges, or the like) while permitting alignment of the first and second blank portions 14a, 14b during an embossing procedure. Although the folder portion 12 is shown as a one-piece structure such that the hinge 18 is integral with and formed from the same material as that of the first and second flaps 16a, 16b, it will be appreciated that the hinge 18 may alternatively include one or more separate components (e.g., a first flange pivotably joined to a second flange by way of a pin, not shown) that join a first flap, 16a to a second flap 16b that are not integrally-formed with one another (not shown); however, it will be appreciated that a one-piece structure shown and described in the Figures obviates separate forming procedures (for the above-described alternative embodiment) while also saving time in assembling the components to one another (for the above-described alternative embodiment) while also preventing the possibility of losing one or more of the components (i.e., one or more of the first flap 16a, second flap 16b or hinge 18 for the above-described alternative embodiment).

In an embodiment, the first flap 16a generally defines an inner surface 20a (see, e.g., FIG. 1C) and an outer surface 22a (see, e.g., FIGS. 1A, 1B) as the second flap 16b similarly defines an inner surface 20b and an outer surface 22b (see, e.g., FIGS. 1A, 1B). When the first flap 16a is moved proximate the second flap 16b (see, e.g., FIG. 4E), the inner surface 20a of the firsts flap 16a may be disposed near or substantially adjacent the inner surface 20b of the second flap 16b.

In an embodiment, the folder 12 may include any desirable rigid material. In an embodiment, the folder 12 may include a substantially rigid thermoplastic material including, for example, polycarbonate (PC), polyvinylchloride (PVC) or the like. In an embodiment, the folder 12 may include a substantially transparent material in order to permit a user to see a design, pattern or the like defined by the first and second blank portions 14a, 14b.

Referring to FIG. 1A, in an embodiment, the blank portion workpiece 14 may include a plurality of layers 24 that are defined, for example, by a base material layer 24a, a first film layer 24b and a second film layer 24c. In an embodiment, each layer 24a-24c of the blank portion workpiece 14 includes a length, L, and a width, W, that is substantially the same as that of the length, L, and width, W, of each of the first and second flaps 16a, 16b.

In an embodiment, the base material layer 24a defines an upper surface 26 and a lower surface 28. In an embodiment, each of the upper surface 26 and the lower surface 28 includes an adhesive material, A.

In an embodiment, when the plurality of layers 24 defining the blank portion workpiece 14 are assembled together, the adhesive material, A, disposed upon the upper surface 26 is covered by the first film layer 24b by disposing the first film layer 24b adjacent the upper surface 26 of the base material layer 24a. Similarly, the adhesive material, A, disposed upon the lower surface 28 is covered by the second film layer 24c by disposing the second film layer 24c adjacent the lower surface 28 of the base material layer 24a.

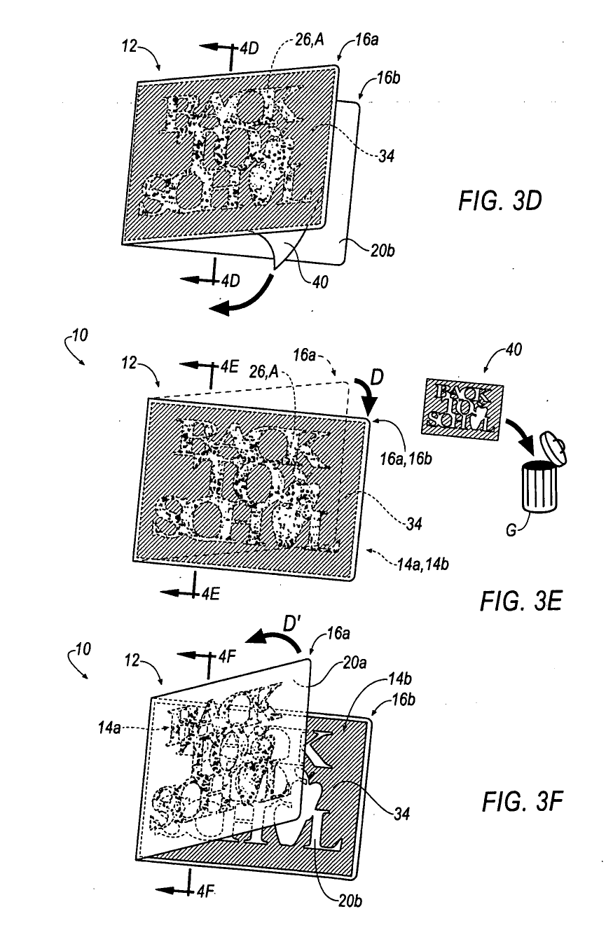

When it is desired to expose the adhesive material, A, at least a portion 36, 40 of the first and second film layers 24b, 24c may be removed from the base material layer 24a (see, e.g., FIGS. 3A, 4A and 3D, 4D respectively). Accordingly, each of the first and second film layers 24b, 24c may also be referred to as release-liner layers.

As seen in FIG. 1A, the blank portion workpiece 14 may be referred to as an unmodified, “virgin” blank portion. Conversely, as seen in FIG. 1B, the “virgin” blank portion workpiece 14 is modified to define the plurality of layers 24 to be separated to define the first blank portion 14a (that includes portions 30, 38 of layers 24a, 24c described in the foregoing disclosure) and the second blank portion 14b (that includes portions 32, 34 of layers 24a, 24b described in the foregoing disclosure).

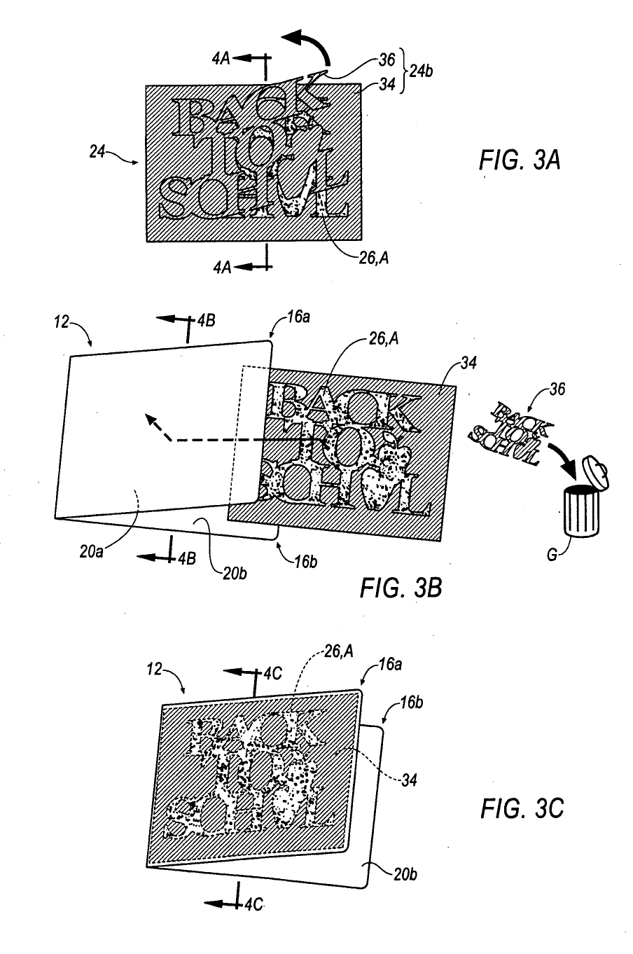

In an embodiment, as seen in FIG. 2, a system 100 may be employed to cut/score all of the plurality of layers 24 defined by the blank portion workpiece 14 in order to permit the formation of the first blank portion 14a and the second blank portion 14b. In an embodiment, the system 100 may include a device 102 having a movable cutting/scoring head 104, which is hereinafter referring to as the head 104. The head 104 may include a blade, liquid, or the like that cuts or scores the blank portion workpiece 14 to define the first blank portion 14a and the second blank portion 14b.

It will be appreciated that the terms “cut” and “score” have unique meanings when discussing the modification of the blank portion workpiece 14. For example, if the blank portion workpiece 14 is said to be “cut,” the blank portion workpiece 14 may be modified by an incision that extends substantially all the way through a thickness, T, of the blank portion workpiece 14. Further, for example, in an embodiment, if the blank portion workpiece 14 is said to be “scored,” the blank portion workpiece 14 may be modified by an incision that extends partially into the thickness, T, of the blank portion workpiece 14. In an embodiment, it will be appreciated that a length of the “cutting” or “scoring” of the blank portion workpiece 14 may include a plurality of/series of “cuts” or “scores” that defines the blank portion workpiece 14 to be substantially perforated.

In an embodiment, the device 102 may be an electronic apparatus, and, for example, movements of the head 104 may be controlled by a processor, controller, or the like. In an embodiment, the device 102 is described in detail in application Ser. No. 11/457,419, filed Jul. 13, 2006, to Robert Workman et al., the contents of which are incorporated herein by reference. However, it will be appreciated that the device 102 is not limited to an electronic apparatus and that a non-electronic, manually operated device may be provided in order to cut/score the blank portion workpiece 14.

As seen in FIGS. 1B and 3A-4F, as a result of the blank portion workpiece 14 defined by the plurality of layers 24 being cut or scored by the head 104, the base material layer 24a is generally separated into a first portion 30 and a second portion 32. Similarly, the first film layer 24b is generally separated into a first portion 34 and a second portion 36. Similarly, the second film layer 24c is generally separated into a first portion 38 and a second portion 40.

As will be described in the foregoing disclosure, the second portions 36, 40 of the first and second film layers 24b, 24c are removed from the plurality of layers 24 and discarded (shown generally being disposed into a garbage can, G, at FIGS. 3B and 3E) during the manufacture of the embossing device 10. Accordingly, as seen in FIG. 1B, the first blank portion 14a is generally defined by the first portion 30 of the base material layer 24a and the first portion 38 of the second film layer 24c, and, the second blank portion 14b is generally defined by the second portion 32 of the base material layer 24a and the first portion 34 of the first film layer 24b.

In an embodiment, as seen in FIG. 2, if the device 102 is an electronic apparatus, the device 102 may be interfaced with a cartridge 106 and/or a computer workstation 108. The cartridge 106 may be, for example, a memory device (e.g., flash memory, a jump drive, or the like) that includes movement instructions for the head 104. In an embodiment, the cartridge 106 may include a label or indicia, I, representing an image in order to communicate to a user how the head 104 will be moved so as to define the first and second blank portions 14a, 14b.

Alternatively, in an embodiment, a user may operate the computer workstation 108 to manually create an electronic design, pattern or the like defined by a plurality of pixels on a monitor 110 of the computer workstation 108. The pixel pattern may be provided as an input to a program that creates instructions for defining movement of the head 104 in order to create the first blank portion 14a and the second blank portion 14b. In an embodiment, the electronic, manually-created pattern or design created by the user on the monitor 110 may be saved in memory of the computer workstation 108, and/or, saved to the cartridge 106.

In an embodiment, the cartridge 106 may be directly connected to the device 102 at a data port 112 defined by the device 102; accordingly, it will be appreciated that the device 102 may be operated separately from and without the computer workstation 108. Although the cartridge 106 is shown to be directly interfaced with the device 102, it will be appreciated that the cartridge 106 may be directly interfaced with the computer workstation 108 at a data port (not shown) that is substantially similar to the data port 112. In an embodiment, the data port 112 may be, for example, a universal serial bus (USB) port or the like.

In an embodiment, it will be appreciated that the device 102 may be utilized to cut/score all of the plurality of layers 24 in the comfort of one's home such that the first and second blank portions 14a, 14b may be connected to the folder portion 12 as described in the foregoing disclosure at FIGS. 3A-3F and 4A-4F. However, it will be appreciated that the first and second blank portions 14a, 14b do not have to be created locally within one's home by the device 102 and that pre-modified first and second blank portions 14a, 14b may be manufactured remotely from the user's home such that the first and second blank portions 14a, 14b may be purchased as a commercially available accessory as an after-market component.

Further, it will be appreciated that a user may purchase one or more cartridges 106 having previously-saved designs or patterns for forming first and second blank portions 14a, 14b. Even further, it will be appreciated that a single cartridge 106 may store a plurality of designs or patterns that are either previously-created by a manufacturer, manually-created by an end-user, and/or downloaded from the Internet from a manufacturer's or user's website. Although it is described above that a cartridge (i.e., an external, interfacable memory device) may be utilized in a number of ways to save/download designs, patterns or the like, it will be appreciated that the device 102 may include an internal, non-interfacable memory device that may be wired to or wirelessly interfaced with the Internet in order to save/download designs, patterns or the like as described above in a substantially similar manner as that with the removable cartridge 106.

Referring now to FIGS. 3A-3F and 4A-4F, a method for manufacturing the embossing device 10 is described in accordance with an embodiment of the invention. First, as seen in FIGS. 3A and 4A, a user removes the second portion 36 of the first film layer 24b in order to expose a portion of the adhesive material, A, disposed upon the upper surface 26 of the first portion 30 of the base material layer 24a.

Referring to FIGS. 3B and 4B, upon removing the second portion 36 of the first film layer 24b, the first film portion 34 is carried by the upper surface 26 of base material layer 24a. In an embodiment, the second portion 36 of the first film layer 24b may be no longer needed, and, as such, may be discarded into a receptacle, recycling bin, trash can, garage can, G, or the like.

Then, as seen in FIGS. 3B-3C and 4B-4C, the user places the exposed adhesive material, A, of the upper surface 26 of the first portion 30 of the base material layer 24a adjacent the inner surface 20a of the first flap 16a of the folder portion 12. As a result of placing the exposed adhesive material, A, of the upper surface 26 of the first portion 30 of the base material layer 24a adjacent the inner surface 20a of the first flap 16a of the folder portion 12, the first blank portion 14a is said to be attached to the first flap 16a of the folder portion 12. It will be appreciated that upon attaching the first blank portion 14a to the first flap 16a as described above, the second blank portion 14b is joined to and carried by the first blank portion 14a.

Then, as seen in FIGS. 3D and 4D, the user removes the second portion 40 of the second film layer 24c in order to expose a portion of the adhesive material, A, disposed upon the lower surface 28 of the second portion 32 of the base material layer 24a. Then, as seen in FIGS. 3E and 4E, the user moves the first flap 16a of the folder portion 12 in a first direction according to the arrow, D, in order to locate the inner surface 16a of the first flap 16a of the folder portion 12 proximate the inner surface 20b of the second flap 16b of the folder portion 12 in order to place the exposed adhesive material of the lower surface 28 of the second portion 32 of the base material layer 24a adjacent the inner surface 20b of the second flap 16b. In an embodiment, the second portion 40 of the second film layer 24c may be no longer needed, and, as such, may be discarded into a receptacle, recycling bin, trash can, garage can, G, or the like.

Referring to FIGS. 3F and 4F, the user moves the first flap 16a in a second direction according to the arrow, D′, that is substantially opposite the direction of the arrow, D, in order to move the inner surface 20a of the first flap 16a of the folder portion 12 away from the inner surface 20b of the second flap 16b of the folder portion 12. As a result of placing the exposed adhesive material of the lower surface 28 of the second portion 32 of the base material layer 24a adjacent the inner surface 20b of the second flap 16b of the folder portion 12, the second blank portion 14b is said to be attached to the second flap 16b of the folder portion 12.

Further, as seen in FIGS. 3F and 4F, by moving the first flap 16a according to the direction of arrow, D′, the second blank portion 14b is no longer joined to or carried by the first blank portion 14a. As illustrated, the second blank portion 14b is separated from the first blank portion 14a by moving the first flap 16a according to the direction of arrow, D′.

Further, as seen in FIG. 4F, it will be appreciated that the first blank portion 14a attached to the first flap 16a of the folder portion 12 does not include all three layers 24a-24c of the plurality of layers 24. As illustrated, the first blank portion 14a attached to the first flap portion 16a includes the first portion 30 of base material layer 24a and the first portion 38 of the of the second film layer 24c. Similarly, the second blank portion 14b attached to the second flap 16b of the folder portion 12 does not include all three layers 24a-24c of the plurality of layers 24; as illustrated, the second blank portion 14b attached to the second flap portion 16b includes the second portion 32 of the base material layer 24a and the first portion 34 of the first film layer 24a.

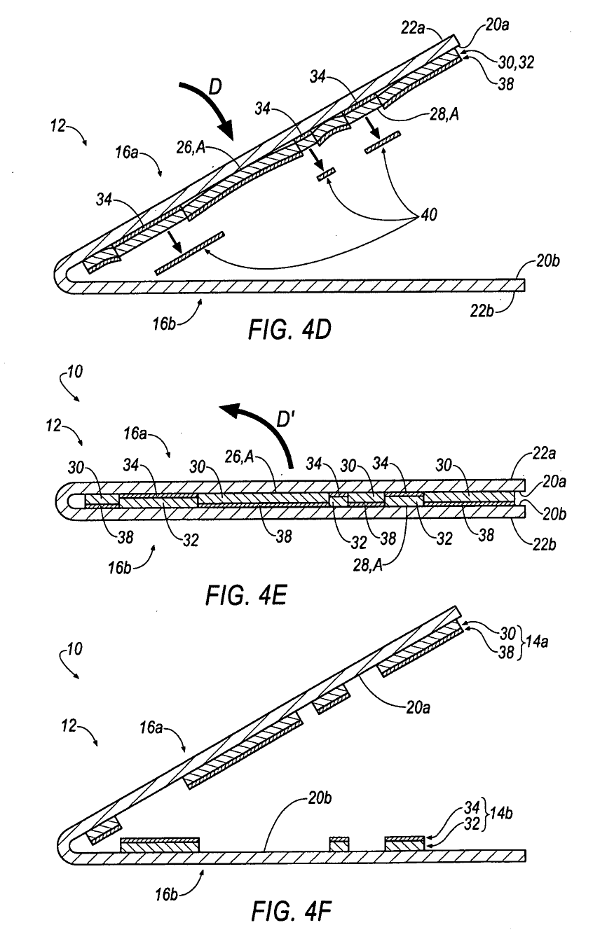

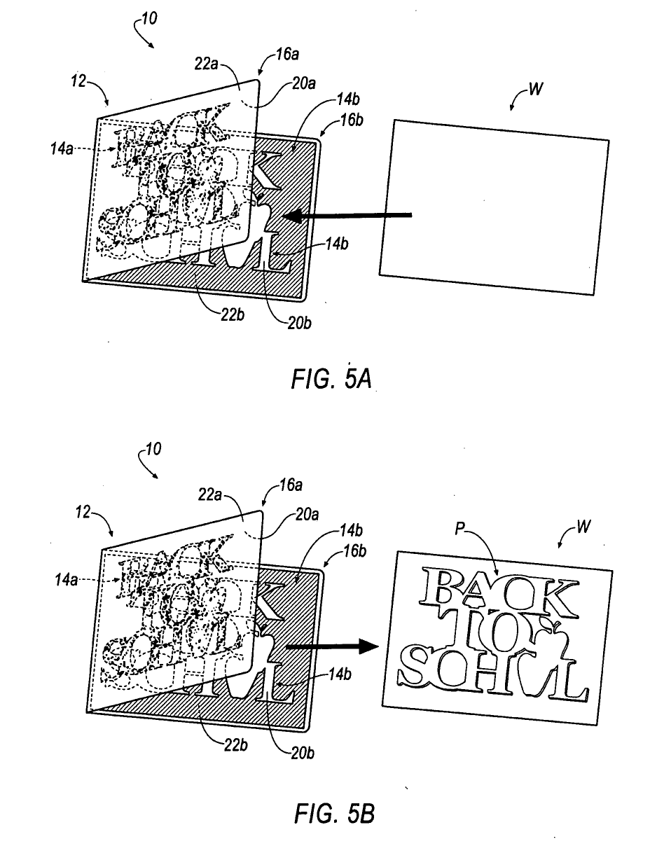

Referring to FIG. 5A, once the embossing device 10 is formed as described in the embodiment above, the embossing device 10 may be utilized for creating an embossed pattern, P (see, e.g., FIG. 5B), design or the like upon a workpiece, W. The workpiece, W, may include any desirable material, such as, for example, paper, construction paper, poster-board, cardboard or the like.

In an embodiment, the workpiece, W, including the embossed pattern, P, may be associated with a scrap-book. However, it will be appreciated that the workpiece, W, including the embossed pattern, P, may be utilized in any desirable, non-scrap-booking application, as desired.

In general, the folder portion 12 carrying the first and second blank portions 14a, 14b is moved to an open position (by moving the first flap 16a away from the second flap 16b according to the direction of arrow, D′) such that the workpiece, W, may be permitted to be interfaced with the embossing device 10. Then, the workpiece, W, is disposed between the inner surfaces 20a, 20b of the first and second flaps 16a, 16b. Then, the folder portion 12 is moved to the closed position (by moving the first flap 16a toward the second flap 16b according to the direction of the arrow, D) by moving the inner surfaces 20a, 20b proximate one another in order to sandwich the workpiece, W, by the first and second flap portions 16a, 16b.

Once the workpiece, W, is sandwiched by the first and second flaps 16a, 16b, the user may pinch/apply pressure to each of the outer surfaces 22a, 22b of the first and second flap portions 16a, 16b in order to cause the first blank portion 14a to be disposed proximate the inner surface 20b of the second flap portion 16b as the second blank portion 14b is disposed proximate the inner surface 20a of the first flap portion 16a so as to impart the pattern, P, or design defined by the first and second blank portions 14a, 14b upon the workpiece, W. In an embodiment, the pinching/application of pressure to each of the outer surfaces 22a, 22b of the first and second flap portions 16a, 16b may be done manually with a user's hands.

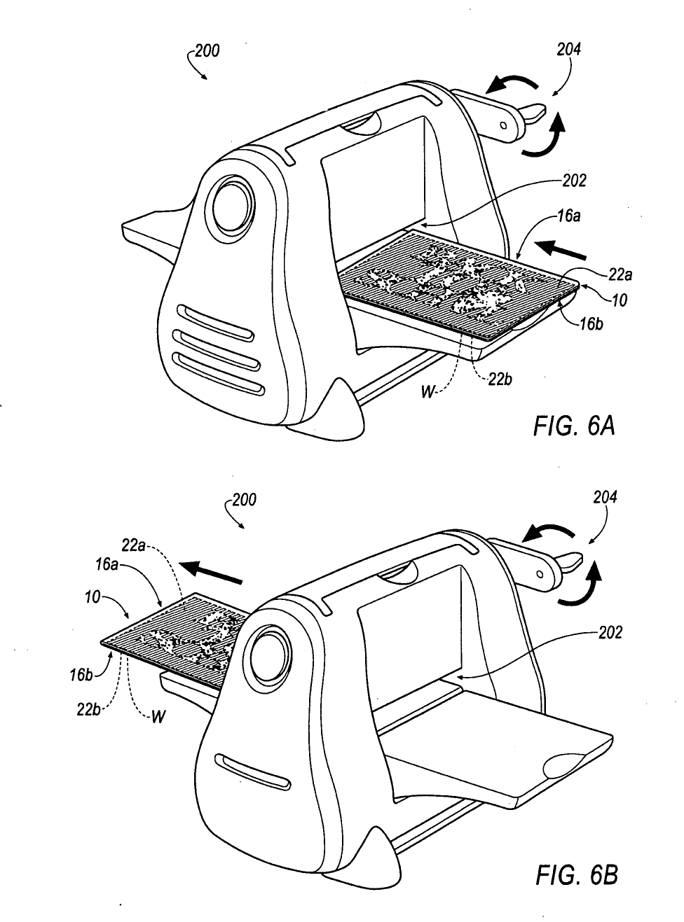

In an alternative embodiment, as seen in FIGS. 6A-6B, it will be appreciated that the embossing device 10 including the sandwiched workpiece, W, may be interfaced with a pressing device 200 that imparts the above-described pinching/application of pressure to each of the outer surfaces 22a, 22b of the first and second flap portions 16a, 16b. In an embodiment, the device 200 is described in detail in application Ser. No. 11/669,088, filed Jan. 30, 2007, to Gerry Ayala et al., the contents of which are incorporated herein by reference.

In an embodiment, the embossing device 10 including the sandwiched workpiece, W, may be inserted into an insertion slot 202 formed in the pressing device 200, and, upon turning a crank 204 of the pressing device 200, the embossing device 10 and workpiece, W, may be fed through the pressing device 200 and out of a discharge slot (not shown) formed opposite the insertion slot 202. As the embossing device 10 and workpiece, W, are fed through the insertion slot 202, a force-imparting portion, such as, for example, a pair of opposing rollers (not shown), may contact the outer surfaces 22a, 22b with sufficient force in order to compress the embossing device 10 such that the first and second blank portions 14a, 14b impart the embossed design, pattern, P, or the like to the workpiece, W, that is sandwiched between the first and second flaps 16a, 16b of the folder portion 12.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. An assembly, comprising:
an embossing device including
a blank portion workpiece including a plurality of layers, wherein the blank portion workpiece is separated to include
a first blank portion, and
a second blank portion, wherein each of the first and second blank portions include portions of at least two layers of the plurality of layers; and
a blank portion retainer including a first flap and a second flap, wherein the first flap and the second flap are connected by a member consisting of
a hinge, wherein the hinge and the first flap and the second flap define a folder, wherein each of the first and second flaps define an inner surface and an outer surface, wherein the first blank portion is attached to the inner surface of the first flap, wherein the second blank portion is attached to the inner surface of the second flap.

2. The assembly according to claim 1, wherein the embossing device defines
means for imparting an embossed design or pattern to a workpiece.

3. The assembly according to claim 1, wherein the plurality of layers of the blank portion workpiece includes
a base material layer defining an upper surface and a lower surface, wherein each of the upper and lower surfaces include an adhesive,
a first film release layer disposed adjacent the upper surface, and
a second film release layer disposed adjacent the lower surface.

4. The assembly according to claim 3, wherein each of the base material layer, the first film release layer and the second film release layer are defined to include a first portion and a second portion.

5. The assembly according to claim 4, wherein
the first blank portion exclusively includes the first portion of the base material layer and the first portion of the first film release layer, wherein the adhesive of the upper surface of the base material layer is disposed adjacent the inner surface of the first flap, and wherein
the second blank portion exclusively includes the second portion of the base material layer and the first portion of the second film release layer, wherein the adhesive of the lower surface of the base material layer is disposed adjacent the inner surface of the second flap.

6. The assembly according to claim 1, wherein the hinge provides
means for ensuring that the first blank portion and the second blank portion are repeatably and consistently aligned with one another when the first flap and the second flap are moved toward one another.

7. The assembly according to claim 1, wherein the folder is a one-piece, integrally-formed structure that is free of blank portion alignment connection structure.

8. An assembly, comprising:
a kit for forming an embossing device including
a blank portion workpiece including a plurality of layers, wherein the blank portion workpiece is adapted for being separated into
a first blank portion, and
a second blank portion, wherein each of the first and second blank portions include portions of at least two layers of the plurality of layers; and
a blank portion retainer including a first flap and a second flap, wherein the first flap and the second flap are connected by a member consisting of
a hinge, wherein the hinge and the first flap and the second flap define a folder, wherein each of the first and second flaps define an inner surface and an outer surface, wherein the first blank portion is adapted to be attached to the inner surface of the first flap, wherein the second blank portion is adapted to be attached to the inner surface of the second flap.

9. The assembly according to claim 8, wherein the embossing device defines
means for imparting an embossed design or pattern to a workpiece.

10. The assembly according to claim 8, wherein the plurality of layers of the blank portion workpiece includes
a base material layer defining an upper surface and a lower surface, wherein each of the upper and lower surfaces include an adhesive,
a first film release layer disposed adjacent the upper surface, and
a second film release layer disposed adjacent the lower surface.

11. The assembly according to claim 10, wherein each of the base material layer, the first film release layer and the second film release layer are defined to include a first portion and a second portion.

12. The assembly according to claim 11, wherein
the first blank portion exclusively includes the first portion of the base material layer and the first portion of the first film release layer, wherein the adhesive of the upper surface of the base material layer is disposed adjacent the inner surface of the first flap, and wherein
the second blank portion exclusively includes the second portion of the base material layer and the first portion of the second film release layer, wherein the adhesive of the lower surface of the base material layer is disposed adjacent the inner surface of the second flap.

13. The assembly according to claim 8, wherein the hinge provides
means for ensuring that the first blank portion and the second blank portion are repeatably and consistently aligned with one another when the first flap and the second flap are moved toward one another.

14. The assembly according to claim 8, wherein the folder is a one-piece, integrally-formed structure that is free of blank portion alignment connection structure.
